(19) United States
(12) Patent Application Publication
(10) Pub. No.: US 2003/0073462 A1
(43) Pub. Date: Apr. 17, 2003

(54) Adding control keys to mobile device via smart interchangeable cover

(76) Inventors: Peter Zatloukal, Duvall, WA (US); G. Eric Engstrom, Kirkland, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/301,431

(22) Filed: Nov. 20, 2002

Related U.S. Application Data
(63) Continuation-in-part of application No. 10/087,098, filed on Mar. 1, 2002.
(63) Continuation-in-part of application No. 09/932,154, filed on Aug. 17, 2001.
(60) Provisional application No. 60/306,326, filed on Jul. 17, 2001.
(60) Provisional application No. 60/292,123, filed on May 17, 2001.

(51) Int. Cl. H04B 1/38

(52) U.S. Cl. 455/558; 455/90; 455/347

(57) ABSTRACT

An interchangeable cover is endowed with one or more control keys and complementary electronics to add the control keys to an attached mobile device, which may e.g. be a wireless mobile phone. In one embodiment, the control keys are designed to be used with an alternate display orientation of the attached mobile device. In one embodiment, the control keys are control keys of a game pad. In one embodiment, the cover is U-shaped. In a wireless mobile phone embodiment, the cover is attached to a rotabable sub-section of a pivotable section.

### RELATED APPLICATION

This application is a continuation-in-part application, claiming priority to

(a) U.S. patent application Ser. No. 10/087,098, filed Mar. 1, 2002, entitled “PERSONALIZING ELECTRONIC DEVICES AND SMART COVERING”, which itself claims priority to its provisional filing No. 60/306,326, on Jul. 17, 2001;

(b) U.S. patent application Ser. No. 09/932,154, filed Aug. 17, 2001, entitled “MOBILE ELECTRONIC DEVICE AND COVERING FOR SIMILAR DEVICES WITH ORNAMENT ATTACHMENT MECHANISM”, which itself claims priority to its provisional filing No. 60/292,123, on May 17, 2001; and

(c) U.S. Provisional Application No. 60/418,925, filed Oct. 15, 2002, entitled “Adding Control Keys to Mobile Device via Smart Interchangeable Cover”.

### FIELD OF THE INVENTION

The present invention relates to the field of mobile devices. More specifically, the present invention is related to adding control keys to mobile devices, such as wireless mobile phones, personal digital assistants (PDA) and so forth, via smart interchangeable covers.

### BACKGROUND OF THE INVENTION

Advances in microprocessor and telecommunication technology have led to wide spread deployment and adoption of mobile devices, such as wireless mobile phones and PDA. For wireless mobile phones, in addition to wireless telephony, the late models are often equipped with advanced capabilities, such as calendar, address book, games, access to the World Wide Web (WWW), emails, instant messaging, and so forth. Similarly, for PDA, in addition to calendar and address book functions, the late models are often equipped with advanced capabilities, such as wireless telephony, word processing, spreadsheets, and so forth. In other words, for advanced models, there are increasing cross over or convergent of the functionalities.

However, because of the compactness of the mobile device, typically only limited number of control keys are available to operate these advanced functionalities. For example, in the case of wireless mobile phones, typically only a 12-key keypad plus a handful of control buttons are available, and in the case of PDA, only a handful of control buttons are available. As a result, usability and in turn the user experience of these advanced functions are poor, which in turn leads to the reduced acceptance of the advanced functions, removal of economic incentives for further development and introduction of the advanced functions.

Some prior art mobile devices support the provision of addition control keys, such as an alphabet keys, through the attachment of a peripheral device, such as a keyboard, to an I/O port of the mobile device. However, as described earlier, because of the inherit compactness of mobile devices, only limited number of I/O ports, typically one, is available for attachment of external peripherals.

Thus, a need exists for an alternate more flexible approach to adding control keys to a mobile device.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a perspective view of an interchangeable cover incorporated with one aspect of the teachings of the present invention, in accordance with one embodiment;

FIG. 2 illustrates another perspective view of the interchangeable cover of FIG. 1;

FIG. 3 illustrates a perspective view of the interchangeable cover of FIG. 1 having been removably mated with a complementary core unit of a mobile device, in accordance with one embodiment;

FIG. 4 illustrates an architectural view of the relevant electronic elements of the interchangeable cover of FIG. 1, in accordance with one embodiment;

FIG. 5 illustrates an architectural view of the mobile device of FIG. 3, in accordance with one embodiment;

FIG. 6 illustrates the operational flow of the relevant aspects of the device driver of FIG. 5, in accordance with one embodiment;

FIG. 7 illustrates a perspective view of an interchangeable cover incorporated with another aspect of the teachings of the present invention, in accordance with another embodiment;

FIG. 8 illustrates an exploded view of another mobile device, having an interchangeable cover of a face plate type, incorporated with the teachings of the present invention, in accordance with another embodiment; and

FIGS. 9a-9c illustrate another mobile device, on which the present invention may be practiced, in accordance with yet another embodiment.

### DETAILED DESCRIPTION OF EMBODIMENTS OF THE INVENTION

The present invention includes an interchangeable cover equipped to add at least one control key to a mobile device.

Parts of the description will be presented in terms, such as mobile devices, control keys, interface, cover and so forth, consistent with the manner commonly employed by those skilled in the art to convey the substance of their work to others skilled in the art. As well understood by those skilled in the art, the terms “mobile devices” as used herein, including in the claims, comprise wireless mobile phones, PDA, and other devices of the like. Similarly, the term “control keys”, as used herein, including in the claims, comprises “control buttons”, and other terms of the like.

The term “cover” as used herein refers to a part that inherently include multiple surfaces that cover at least multiple ones of the exterior surfaces of the body or core unit of a mobile device, where the exterior surfaces are inherently disposed in different geometric planes. Accordingly, while a “cover” may come in many variants, as illustrated by the description to follow, a “card” like part, i.e. a part having the form factor of a “credit card”, a PCMCIA card, a PC card, a Compact Flash card and so forth, is not a “cover”, for the purpose of the present application. A “card” like part, for the purpose of the present application, by definition, is considered to occupy only one geometric plane.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation. The phrase “in one embodiment” is used repeatedly. The phrase generally does not refer to the same embodiment, however, it may. The terms “comprising”, “having” and “including” are synonymous, unless the context dictates otherwise.

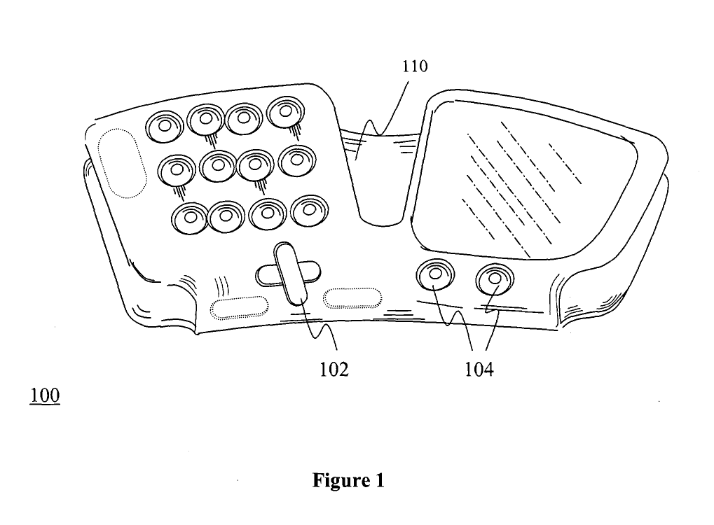

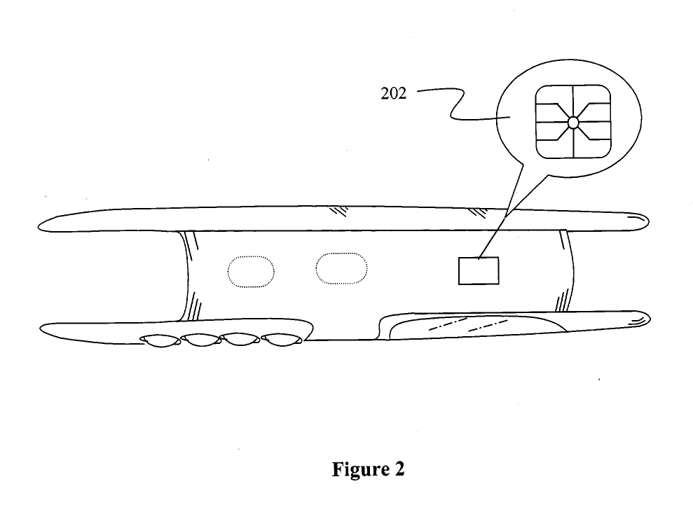

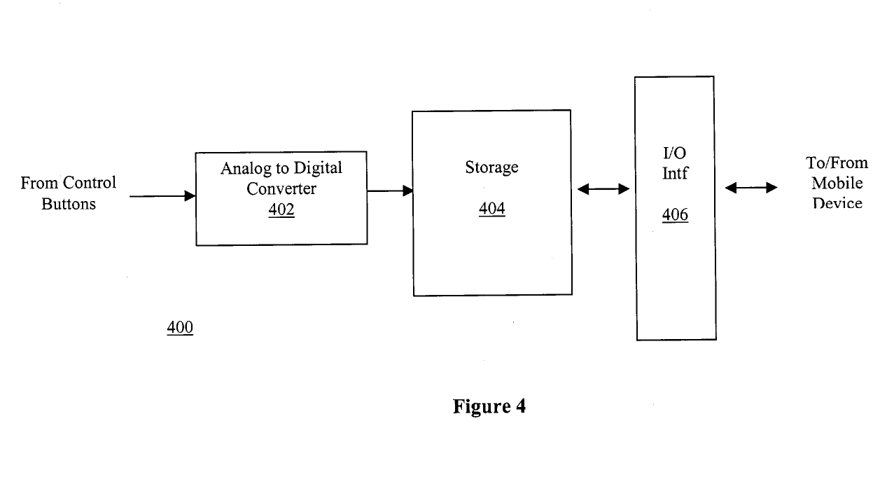

FIG. 1 illustrates an overview of the interchangeable cover of the present invention, in accordance with one embodiment. As illustrated, interchangeable cover 100 of the present invention is advantageously endowed with a number of control keys 102-104 and complementary electronics (see FIGS. 2 and 4) to facilitate addition of control keys 102-104 to a complementarily equipped mobile device, to which interchangeable cover 100 is attached.

For the illustrated embodiment, control keys 102-104 comprise a control key 102 for facilitating a user of the attached mobile device to provide inputs to the attached mobile device along at least two axes, e.g. the X and Y axes, and control keys 104 to facilitate the user in providing two types of inputs.

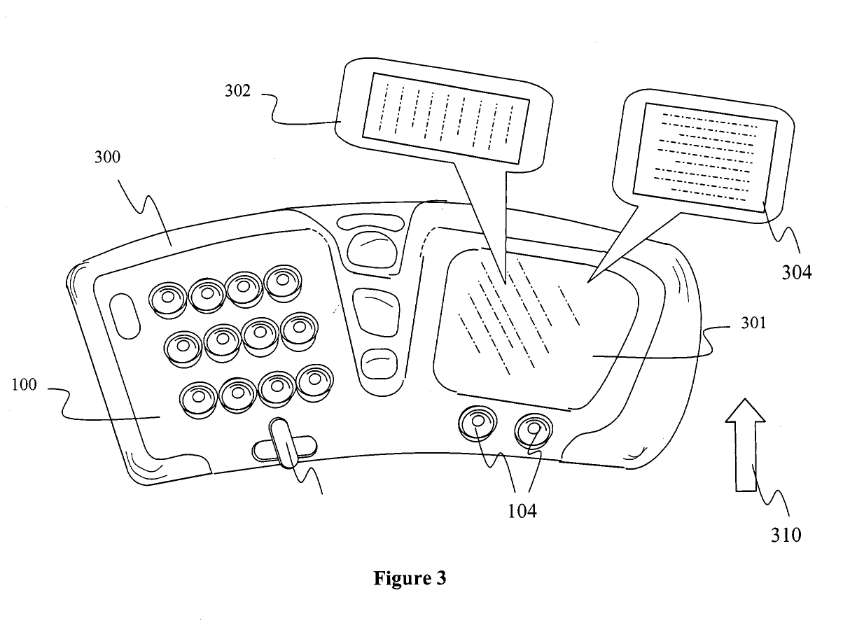

For the illustrated embodiment, control keys 102-104 are disposed near different ends of an edge of the face surface of cover body 110 of cover 100. The disposition is designed to facilitate a user of the attached mobile device to provide inputs to an application that renders output on the display of the attached mobile device in a rotated manner (e.g. by approximately 90 degrees, from “normal” display orientation 302 to “rotated” display orientation 304, see FIG. 3). More specifically, the disposition is designed to facilitate substantial current usage of control keys 102-104 with both hands of the user.

In gaming context, control key 102 may be a “joystick”. Control keys 104 may be known as the A and B keys. In other words, in gaming context, control keys 102-104 form the control keys of a game pad.

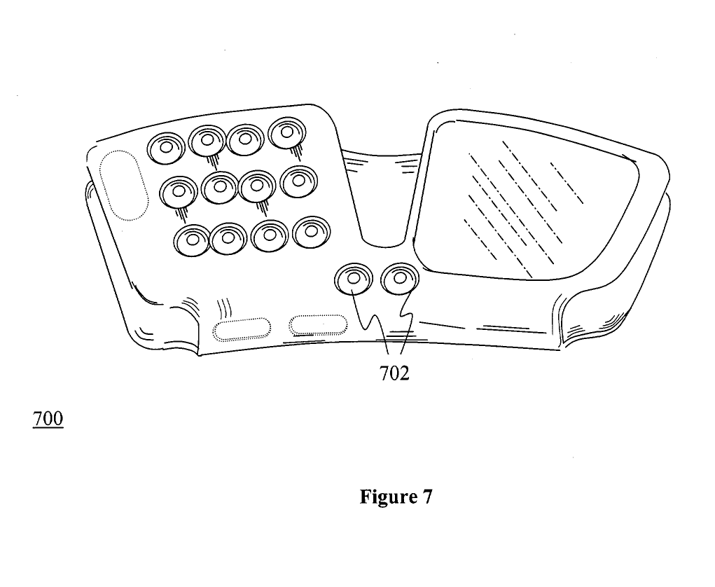

In alternate embodiments, control keys may simply be extra function keys, such as function keys 702 of FIG. 7, being added to the attached mobile device.

Still referring to FIG. 1, for the illustrated embodiment, cover body 110 of cover 100 has a substantially “rotated” U-shape or “taco shell” shape. Cover 100 is designed to attach to a core unit of a mobile device (such as the core unit of wireless mobile phone 300 of FIG. 3), in a side way manner (as denoted by arrow 310 of FIG. 3). For the embodiment, cover body 110 has multiple surfaces occupying different geometric planes, and covers at least partially each of a front, a side and a back exterior surface of the core unit of phone 300. For the embodiment, cover body 110 is designed to be snapped on to the core unit of a mobile device.

In alternate embodiments, cover body 110 may assume a body shape other than the illustrated “rotated” U-shape. Cover body 110 may also be designed to attach to a core unit of a mobile device in manner that is other than a side way manner. Similarly, cover body 110 may also be designed to attach to a core unit of a mobile device in a non-snapped on manner, even employing one or more fasteners. A number of these alternate embodiments are further described later.

As illustrated in FIG. 2, the complementary electronics of cover 100 are packaged as an application specific integrated circuit (ASIC) 202. For the illustrated embodiment, ASIC 202 has output “pins” that are similar to the output pins of embedded ASIC found in what's commonly referred to as “SIM chips”. Further, ASIC 202 is disposed on the inside “side” surface of “rotated” U-shape body 110.

Control keys 102-104 are coupled to ASIC 202 by way of traces disposed on the inside surfaces of “rotated” U-shape body 110. In various embodiments, a protective interior layer may be included with cover body 110 to protect the traces. The protective interior layer may be made of any one of a number of known suitable materials, such as plastics.

In alternate embodiments, ASIC 202 may employ output “pins” of other types. ASIC 202 may be disposed in other location or locations of cover body 110. Further, the complementary electronics may be “packaged” in other manners.

FIG. 3 illustrates a perspective view of cover 100 of the present invention, attached to a core unit of a mobile device. For the illustrated embodiment, mobile device 300 is a wireless mobile phone. In particular, mobile device 300 includes display 301, where an application may render displays in at least one of two orientations, “normal” orientation 302, and “rotated” orientation 304, as described earlier, and an expansion I/O interface (covered by cover 100).

The expansion I/O interface comprises contacts that are complementary to the output “pins” of ASIC 202. Further, the expansion I/O interface is disposed at a location on an outer surface of the core unit of mobile device 300 corresponding to the disposition location of ASIC 202 on cover body 110.

From the descriptions to follow, it shall be readily apparent to one skilled in the art that the present invention may also be practiced with other types of interfaces, as well as with other mobile devices, in particular, personal digital assistants.

FIG. 4 illustrates an architectural view of the relevant complementary electronics, in accordance with one embodiment. For the embodiment, the relevant complementary electronics 400 includes an analog-to-digital converter 402, storage unit 404, and input/output (I/O) interface 406, coupled to each other as shown.

Analog-to-digital converter 402 is employed to digitize the analog signals generated by control keys 102-104 as the user uses them to provide input to mobile device 300. Storage unit 404 is employed to store the digitized input data.

In various embodiments, storage unit 404 may be any one of a number of non-volatile memory known in the art, including but not limited to EEPROM, and so forth. In various embodiments, the storage locations of storage-unit 404 may be memory mapped into the memory space of mobile device 300.

I/O interface 406 facilitates an application or a system service of mobile device 300 in reading the inputs provided using control keys 102-104. As described earlier, I/O interface 406 may be any one of a number of I/O interfaces known in the art.

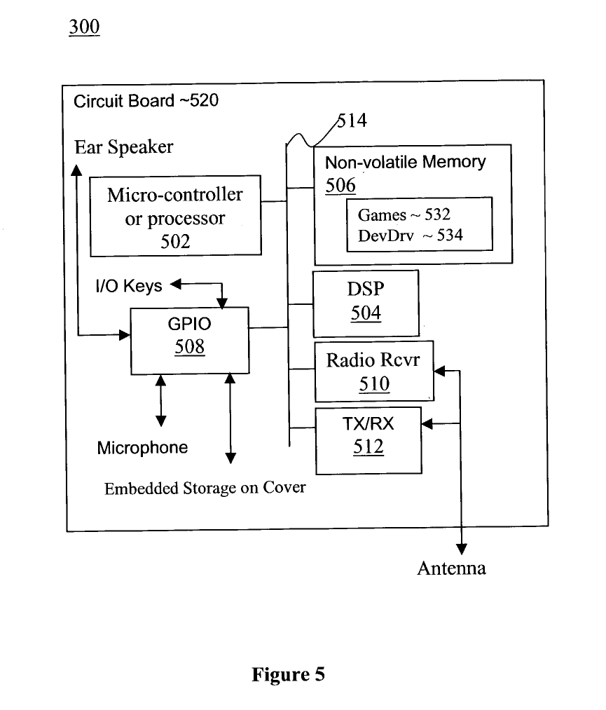

FIG. 5 illustrates mobile device 300 in further detail, in accordance with one embodiment. As alluded to earlier, for the illustrated embodiment, mobile device 300 is a wireless mobile phone; however, for other embodiments, mobile device 300 may be other mobile devices, including but are not limited to PDA.

As illustrated in FIG. 5, the core unit of wireless mobile phone 300 includes conventional elements, such as micro-controller/processor 502, digital signal processor (DSP) 504, non-volatile memory 506, general purpose input/output (GPIO) interface 508, radio receiver 510, and transmit/receive (TX/RX) 512 (also known as a transceiver), coupled to each other via bus 514, and disposed on a circuit board 520.

The core unit of wireless mobile phone 300 is endowed with a software implementation of a device driver 534 in support of the electronics packaged in ASIC 202. In various embodiments, the core unit of wireless mobile phone 300 is also endowed with game applications 532. Further, game applications 532 may require, or operate more enjoyably, with added control keys 102-104.

Except for device driver 534 provided to mobile device 300, which relevant operating logic will be described more fully below, each of these elements 502-514 performs its conventional function known in the art, and is intended to represent a broad range of such element and its equivalents. In particular, GPIO 508 is configured to generate an interrupt notifying control processor 502 of data read from cover 100, which in turn directly or indirectly causes an application of mobile device 300 to be invoked and process the data read. Further, TX/RX 512 may be designed to support one or more of any of the known signaling protocols, including but are not limited to CDMA, TDMA, GSM, and so forth. Moreover TX/RX 512 may be implemented using separate transmitter and receiver.

Accordingly, elements 502-514 will not be further described.

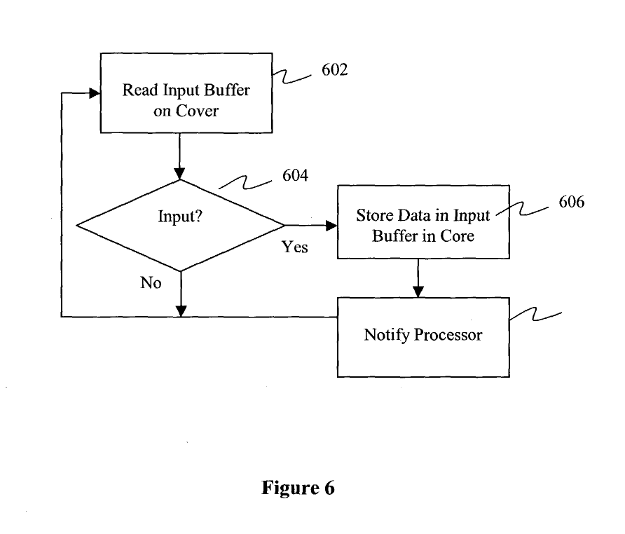

As illustrated in FIG. 6, upon invocation, device driver 534 of mobile device 300 attempts to read the memory mapped storage locations of cover 100 (hereinafter, simply input buffer on cover 100), block 602. At block 604, device driver 534 determines if data were present and read. If no data were present and read, the process continues back at block 602.

However, if data were read, device driver 534 stores the data read in storage locations of memory 506 of mobile device 300 (hereinafter, simply, input buffer in mobile device 300), block 606. As alluded to earlier, device driver 534 further notifies processor 502, causing an application to process the data read, block 608. Thereafter, the process continues back at block 602 again.

Accordingly, data may be advantageously inputted for mobile device 300 using added control keys 102-104.

### Alternate Embodiments

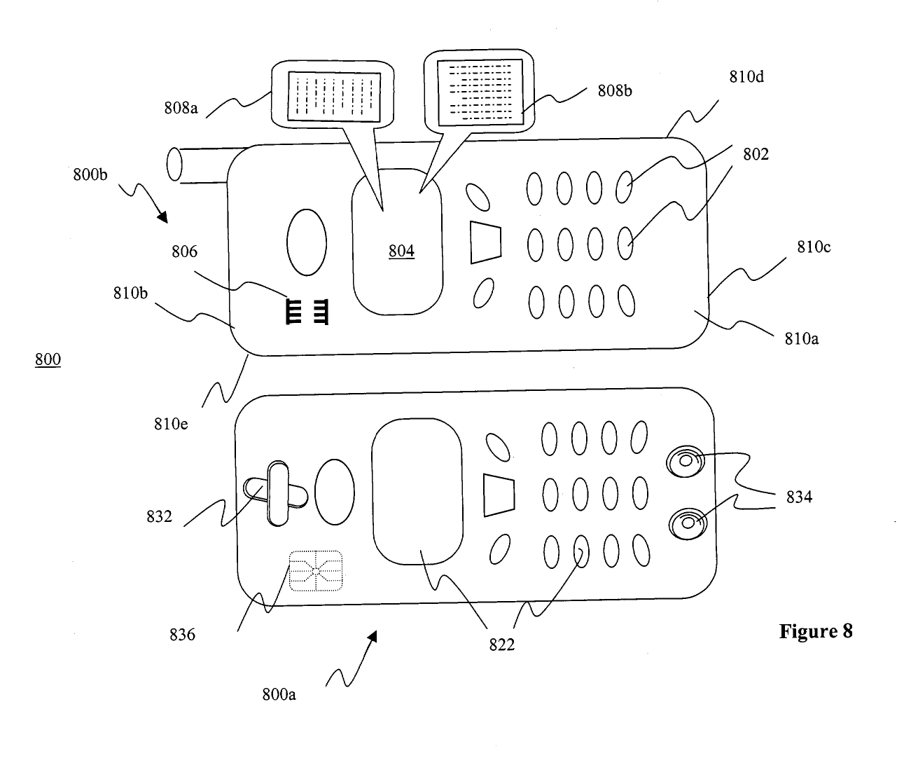

FIG. 8 illustrates an alternate embodiment of the present invention. More specifically, FIG. 8 illustrates an exploded view of a mobile phone 800 having core unit 800b and cover 800a, endowed with the teachings of the present invention. Similar to mobile phone 300 of FIG. 3, core unit 800b of mobile phone 800 includes in particular, a number of input keys 802, display 804, expansion interface 806, and internal components similar to those of FIG. 5. As described earlier, the internal components are equipped with logic to enable the addition of control keys 832-834 to mobile phone 800, including enabling displays be rendered on display 804 in one of at least two orientations 808a-808b. Further, core unit 800b includes a front and a number of side and end exteriors surfaces 810a-810e, disposed in different geometric planes.

Cover 800a is of a face plate type, having “cut outs” 822, to facilitate mating with core unit 800b. When mated, cover 800a covers at least front surface 810a and one of the side and end surfaces 810b-810e of core unit 800b. As the embodiment of FIG. 1, cover 800a includes a number of control keys 832-834, such as game and function keys, and electronic component 836 having earlier described complementary logic, to add control/function keys 832-834 to mobile device 800.

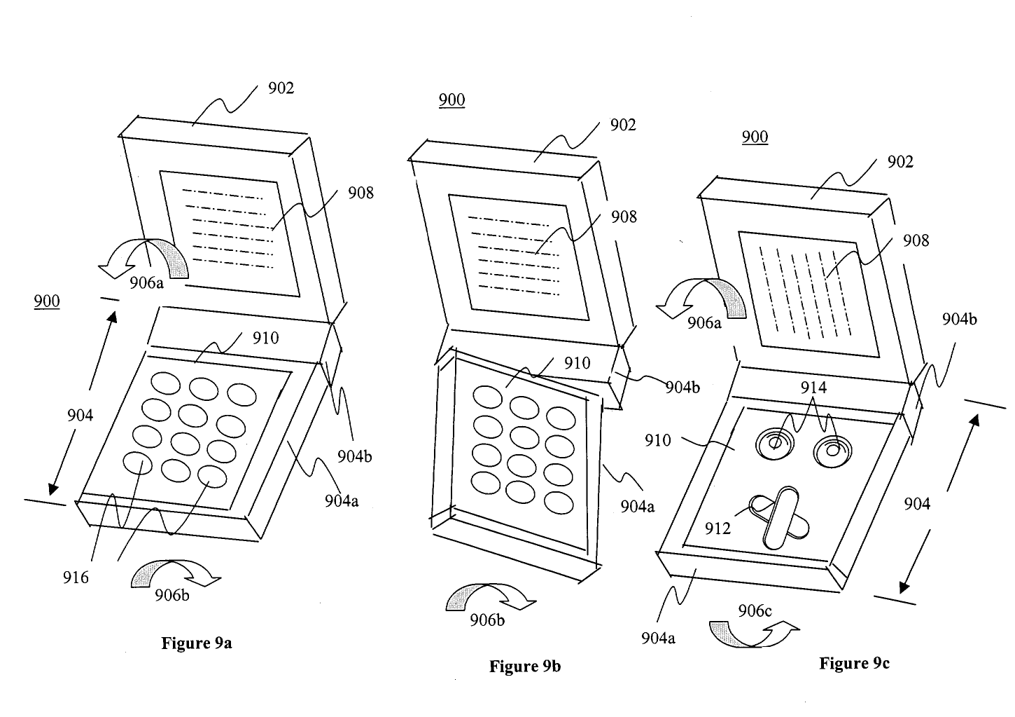

FIGS. 9a-9c illustrate yet another embodiment of the present invention. More specifically, FIGS. 9a-9c illustrate three mated views of a mobile phone 900 having a core unit and cover 910, endowed with the teachings of the present invention. Unlike the earlier described embodiments, the core unit of mobile phone 900 has a multi-section form factor comprising a first section 902 and a second section 904, and the second section 904 is further comprised of at least two sub-sections 904a-904b. The first and second sections 902-904 may pivot towards each other as denoted by direction arrow 906a or away from each other opposite to the direction denoted by arrow 906a. Sub-section 904a may rotate relative to sub-section 904b as denoted by the directions denoted by arrows 906b-906c. In other words, mobile phone 900 may be considered as an improved version of what is commonly referred to as “flip” phones.

Similar to mobile phones 300 and 800 of FIG. 3 and 8, the core unit of mobile phone 900 includes in particular, display 908, a number of input keys and expansion interface (covered by cover 910), and internal components similar to those of FIG. 5. As described earlier, the internal components are equipped with logic to enable displays be rendered on display 908 in one of at least two orientations (see FIGS. 9a-9b and 9c). Thus, for the display orientation of FIG. 9a-9b, sections 902-904 may be thought of as the “top” and “bottom” sections of mobile phone 900, whereas for the display orientation of FIG. 9c, sections 902-904 may be thought of as the “right” and “left” sections of mobile phone 900. As will be readily apparent from the remaining descriptions, by varying either the disposition of the input/control keys, and/or the manner cover 910 attaches to section 904 of mobile phone 900, sections 902-904 may also be configured as the “left” and “right” sections of mobile phone 900. Further, section 904 of mobile phone 900 with which cover 910 is to mate, includes a front and a number of side and end exteriors surfaces, disposed in different geometric planes.

Cover 910 is of a type similar to cover 100 of FIG. 1, except control/function keys 912-914 to be added to mobile phone 900 are disposed on a “back” surface of cover 910. Similar to cover 100, embedded component (not shown) with the supporting logic is also disposed on the inside of the “side” surface. As before, upon mating with mobile phone 900, cover 910 covers at least partially a front surface and one of the side and end surfaces of section 904. For the embodiment, the “standard” input keys and the added control/function keys 912-914 may be made available for usage in conjunction with display 908, by rotating sub-section 904a as illustrated.

### Conclusion and Epilogue

Thus, it can be seen from the above descriptions, a novel method for adding control keys to a mobile device, such as a wireless mobile phone or a PDA, via an interchangeable cover, have been described.

While the present invention has been described in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An interchangeable cover comprising:
a cover body to mate with a body of a mobile device, covering at least partially each of a plurality of exterior surfaces of the body of the mobile device, the exterior surfaces being disposed on different geometric planes;
at least one control key disposed on the cover body;
traces coupled to the at least one control key; and
an electronic component coupled to the traces, and equipped to add the at least one control key as input/control keys of a mobile device to which the interchangeable cover is attached.

2. The cover of claim 1, wherein the cover body is U-shaped and designed to be attached to the mobile device from a side of the mobile device.

3. The cover of claim 1, wherein the cover is a face plate, with the cover body designed to be attached to the mobile device from a front of the mobile device.

4. The cover of claim 1, wherein the at least one control key comprises a control key to facilitate a user of the mobile device to provide input along at least two axes.

5. The cover of claim 4, wherein the at least one control key comprises a joystick.

6. The cover of claim 1, wherein the at least one control key comprises a plurality of game control keys of a game pad.

7. The cover of claim 1, wherein the at least one control key comprises an A control key and a B control key of a game pad.

8. The cover of claim 1, wherein the at least on control key comprises a programmable function key.

9. The cover of claim 1, wherein the at least one control keys comprises a plurality of control keys, with a first and a second subset of the control keys disposed at different ends of an edge of cover body, designed for substantially current usage by a user with both hands.

10. The cover of claim 1, wherein the at least one control keys are designed to be used with an alternate display orientation of the attached mobile device.

11. The cover of claim 1, wherein the electronic component comprises an analog-to-digital (A/D) converter coupled to the traces, a storage unit coupled to the A/D converter and an input/output (I/O) interface coupled to the storage unit.

12. The cover of claim 11, wherein the storage unit comprises EEPROM.

13. The cover of claims 1, wherein the mobile device comprises functionalities of at least a selected one of a wireless mobile phone and a personal digital assistant.

14. The cover of claim 1, wherein the at least one control key is disposed on a first exterior surface of the cover body, and the cover further comprises at least one other input keys disposed on a second exterior surface of the cover body.

15. The cover of claim 14, wherein the cover body is U-shaped, with the first and second exterior surfaces being disposed on the different sides of the U-shape.

16. A mobile device comprising
a core unit including a plurality of input/control keys, at least one extension interface and a plurality of exterior surfaces disposed on different geometric planes; and
an interchangeable cover removably attached to the core unit, covering at least partially each of at least two of said plurality of exterior surfaces of the core unit, the interchangeable cover having at least one additional control keys and electronics, coupled to each other, with at least one aspect of the electronics designed to mate with the at least one extension interface of the core unit to add the at least one additional control keys to the input/control keys of the core unit.

17. The mobile device of claim 16, wherein the interchangeable cover comprises a cover body that is U-shaped, and designed to be attached to the core unit from a side of the core unit.

18. The mobile device claim 16, wherein the interchangeable cover is a faceplate, designed to be attached to the core unit from a front of the core unit.

19. The mobile device of claim 16, wherein the at least one control key of the interchangeable cover comprises a control key to facilitate a user of the mobile device to provide input along at least two axes.

20. The mobile device of claim 19, wherein the at least one control key of the interchangeable cover comprises a joystick.

21. The mobile device of claim 16, wherein the at least one control key of the interchangeable cover comprises a plurality of game control keys of a game pad.

22. The mobile device of claim 16, wherein the at least one control key of the interchangeable cover comprises an A control key and a B control key of a game pad.

23. The mobile device of claim 16, the at least one control key of the interchangeable cover comprises a programmable function key.

24. The mobile device of claim 16, wherein the at least one control keys of the interchangeable cover comprises a plurality of control keys, with a first and a second subset of the control keys disposed at different ends of an edge of the interchangeable cover, designed for substantially current usage by a user with both hands.

25. The mobile device of claim 16, wherein the mobile device comprises at least two display orientations, a standard and at least one alternate display orientation, and the at least one control keys are designed to be used with the alternate display orientation.

26. The mobile device of claim 16, wherein the electronics of the interchangeable cover comprises an analog-to-digital (A/D) converter coupled to the traces, a storage unit coupled to the A/D converter and an input/output (I/O) interface coupled to the storage unit.

27. The mobile device of claim 26, wherein the storage unit comprises EEPROM.

28. The mobile device of claims 16, wherein the core unit comprises functionalities of at least a selected one of a wireless mobile phone and a personal digital assistant.

29. The mobile device of claim 16, wherein the core unit comprises a first and a second section with the second section having a first and a second sub-section where the second-sub-section is rotatable relative to the first sub-section, and the cover removably attaches to the second sub-section of the second section.

30. The mobile device of claim 16, wherein the at least one additional control key is disposed on a first exterior surface of the cover, and the cover further comprises at least one other input key disposed on a second exterior surface of the cover.

31. The mobile device of claim 30, wherein the cover body is U-shaped, with the first and second exterior surfaces being disposed on the different sides of the U-shape.

32. A wireless mobile phone comprising:
a core wireless telephony unit including a first and a second section with the second section having a first and a second sub-section, where the second-sub-section is rotatable relative to the first sub-section and includes a plurality of exterior surfaces disposed on different geometric planes; and
a cover including at least one input/control key, removably mated with the second sub-section covering the the second sub-section at least partially in each of at least two of said plurality of exterior surfaces of the second sub-section.

33. The wireless mobile phone of claim 32, wherein the first and second sections are pivotally coupled to each other.

34. The wireless mobile phone of claim 32 wherein said at least one input/control key comprises a plurality of input/control keys of a game pad.

35. The wireless mobile phone of claim 32 wherein said at least one input/control key comprises a programmable function key.
